(19) United States
(12) Patent Application Publication
(10) Pub. No.: US 2019/0130418 A1
(43) Pub. Date: May 2, 2019

(54) Detection of Avoidance Parameters

(71) Applicant: CertiStar, Inc., Tempe, AZ (US)

(72) Inventor: Shandee Amber Chernow, Phoenix, AZ (US)

(21) Appl. No.: 16/176,930

(22) Filed: Oct. 31, 2018

Related U.S. Application Data
(60) Provisional application No. 62/580,034, filed on Nov. 1, 2017.

(51) Int. Cl. G06Q 30/00; G06Q 50/12

(52) U.S. Cl. CPC G06Q 30/018; G06Q 50/12

(57) ABSTRACT

Computerized systems and methods are provided for identifying avoidance parameters from a food service establishment menu for a diner avoiding one or more foods/food groups (e.g., bacterial outbreaks, food allergies, food intolerances, preferences, dietary restrictions, etc.). The offending, or unsafe, items are detected using input ingredient information as well as information pertaining to kitchen cross-contamination or cross contact possibilities. The diner's items to avoid may be input with common food names and, using a proprietary translation, compared against ingredient lists. Suggested modifications may be identified, generated, and output to re-generate the unsafe items to safe options.

### CROSS-REFERENCE TO RELATED APPLICATIONS

This application claims priority to Provisional Patent Application No. 62/580,034, filed Nov. 1, 2017, and entitled “Multi-Allergen Management,” the entire contents of which is incorporated by reference herein in its entirety.

### BACKGROUND

Food safety is an essential focus of food service and of several federal and local regulatory agencies. There are many requirements around training and food safety practices regarding temperatures, cross-contamination and other factors contributing to food safety. For example, raw meat must always be stored at particular temperatures and positions relative to other food ingredients. Also, when raw meat is handled certain procedures are observed with regard to the sanitization of the surfaces and utensils used in handling that meat. By way of further example, when an outbreak or contamination even occurs relating to a particular ingredient from a manufacturer or provider, it is challenging to determine a complete set of menu items and dishes that are affected. If a restaurant receives information that a batch of celery, for instance, that they are using has been contaminated, they would want to stop serving every dish that includes that celery. These are merely a few examples of issues that arise that may require detailed, methodical data analysis. As a result, it is increasingly difficult to identify every dish that includes the offending item(s) as well as every dish that may have been cross contaminated by the offending item(s).

Food allergens are their own area of food service concerns, in addition to the concerns described above. Current FDA labeling regulations require manufacturer labeling of foods that contain an ingredient that is or contains protein from a major food allergen or the “Top 8” food allergens. The major food allergens are recognized as milk, eggs, fish (e.g., bass, cod), shellfish (e.g., crab, lobster, shrimp), tree nuts (e.g., almonds, walnuts, pecans), peanuts, wheat, and soy. There are currently no labeling regulations for allergens that are outside of the Top 8 list. For food-allergic people who have allergies outside of the Top 8 list or multiple food allergies, it is difficult to determine what foods are safe or unsafe for consumption. This is particularly difficult in restaurants where there is no requirement to provide ingredient lists and where food is prepared in a sometimes rushed environment outside of the diner's control. As a result, the food-allergic diner either does not eat at food service establishments or takes a life-threatening risk in hopes that food is safe for consumption and will be prepared in an attentive matter (e.g., awareness related to inventory items in contact with other foods). There is no current solution to provide food servers or diners the knowledge of each food item that includes, or may include or come into contact with, an identified item to be avoided.

While the Top 8 allergens identified above comprise approximately 90% of food allergic reactions, there are over 170 foods known to have caused food allergic reactions, with sesame and corn thought to be the most prevalent beyond the Top 8 in the United States. Additionally, many of these foods are contained in the ingredient lists of manufactured foods under names other than the common food name (e.g., baking powder is indicative of the presence of corn). The number of possible names for any given common food is significant. This further adds to the difficulties in identifying items to be avoided.

To further add to the burden on food service providers, there are many inventory items in food service that are used for different recipes, or menu items. These inventory items could be simple foods (e.g., apples or ground beef) or they could be manufactured items with their own ingredient lists (e.g., pasta or a spice mixture). There is no current solution for reliably identifying all of the possibly safe items within a menu, and this challenge is more significant if the diner has more than one allergen and/or has allergens outside of the Top 8 allergens. Frequently these diners feel too unsafe to dine, the employees feel too unsafe to feed the diner, or the diner is risking having a severe, life threatening, allergic reaction.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Technologies are provided herein for managing food service items. In particular, embodiments of these technologies utilize a plurality of data stores to identify indications of avoidance parameters and determine a corresponding safety assessment (e.g., safe, unsafe, etc.) including a suggested alteration(s) to an offending food item. The data stores may include the United States Department of Agriculture's Food Composition Database. This database includes over 268,000 individual food items, both packaged and whole. The data stores may also include a secured, proprietary database available to authorized users for input of proprietary food item information such as recipes, proportions, ingredient amounts, etc. The data stores may also include a secured, proprietary translational database created by the technologies herein with common food term mappings (e.g., maltodextrin can be made from corn, rice, potato, and wheat). A computer system utilizes information within the above-described data stores, along with specific, individualized inputs, to identify indications of avoidance parameters and determine safety assessments for each item subject to the query.

### BRIEF DESCRIPTION OF THE DRAWINGS

The present invention is described in detail below with reference to the attached drawing figures, wherein:

FIG. 1 is a block diagram of an exemplary computing environment for providing the invention described herein, in accordance with an embodiment of the present technology;

FIG. 2 depicts aspects of an illustrative operating environment, in accordance with some aspects of the technology described herein;

FIG. 3A is a flow diagram providing an exemplary method for identifying indications of avoidance parameters, in accordance with some aspects of the technology described herein;

FIG. 3B is a flow diagram providing an exemplary method for identifying indications of avoidance parameters, in accordance with some aspects of the technology described herein;

FIG. 4A is a flow diagram providing an exemplary method for identifying indications of avoidance parameters, in accordance with some aspects of the technology described herein;

FIG. 4B is a flow diagram providing an exemplary method for identifying indications of avoidance parameters, in accordance with some aspects of the technology described herein;

FIG. 5 is an exemplary food item breakdown illustrating components and additional information related thereto, in accordance with some aspects of the technology described herein;

FIGS. 6-10 are exemplary graphical user interfaces, in accordance with some aspects of the technology described herein;

FIG. 11 is a flow diagram providing an exemplary method for identifying indications of avoidance parameters, in accordance with some aspects of the technology described herein; and

FIG. 12 is a flow diagram providing an exemplary method for identifying indications of avoidance parameters, in accordance with some aspects of the technology described herein.

### DETAILED DESCRIPTION OF THE INVENTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As one skilled in the art will appreciate, embodiments of the invention may be embodied as, among other things: a method, system, or set of instructions embodied on one or more computer readable media. Accordingly, the embodiments may take the form of a hardware embodiment, a software embodiment, or an embodiment combining software and hardware. In one embodiment, the invention takes the form of a computer-program product that includes computer-usable instructions embodied on one or more computer readable media.

Computer-readable media can be any available media that can be accessed by a computing device and includes both volatile and nonvolatile media, removable and non-removable media. By way of example, and not limitation, computer-readable media comprises media implemented in any method or technology for storing information, including computer-storage media and communications media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Aspects of the technology described herein may be utilized for determining, identifying, and managing avoidance parameters for food items. An avoidance parameter, as used herein, refers generally to any item, ingredient, food category, etc., that is to be avoided for any reason. An application on a user device may be utilized to run a program to identify avoidance parameters. The technology described herein utilizes a plurality of data stores to identify indications of avoidance parameters and determine a corresponding safety assessment including a suggested alteration(s) to an offending food item (e.g., food items including or in contact with one or more avoidance parameters). In food service, as described in more detail herein, there are many challenges to overcome to ensure the safety of each patron/diner/customer. There are currently no tools available that identify all food service items to avoid on a menu for a specific diner based on analytical assessments of proprietary ingredients (down to the whole component), food contact potential, cross-contamination concerns (e.g., shared cooking surfaces), or the like, as described herein. Cross-contamination and cross-contact may be used interchangeably herein.

In this way, embodiments described herein provide improvements to existing technologies related to food item analytics. In particular, embodiments overcome significant limitations of conventional technologies for food item analytics including: (a) that conventional approaches are overly simplistic such that the methods utilized by these conventional approaches give rise to inaccuracies, which results in unsafe or potentially safe items being portrayed as safe, and, sometimes, putting the life of a diner at risk; (b) that they fail to take into account a variety of dynamically changing attributes in a particular situation; and (c) that they are not amenable to continuous monitoring and automatic processing. These problems cannot be overcome by simply using a computer. For example, conventional technologies have failed to develop a system that is able to dynamically check food item information, across a plurality of disparate sources, to automatically identify avoidance parameters. This is because problems with the conventional technology require new and improved techniques that specifically overcome these drawbacks. Hence, the embodiments discussed herein overcome these disadvantages by implementing new and improved techniques and features that are not known in conventional industry practice, thereby providing enhanced food item analytics systems that are capable of producing determinations with a thoroughness and accuracy that has not been previously achieved.

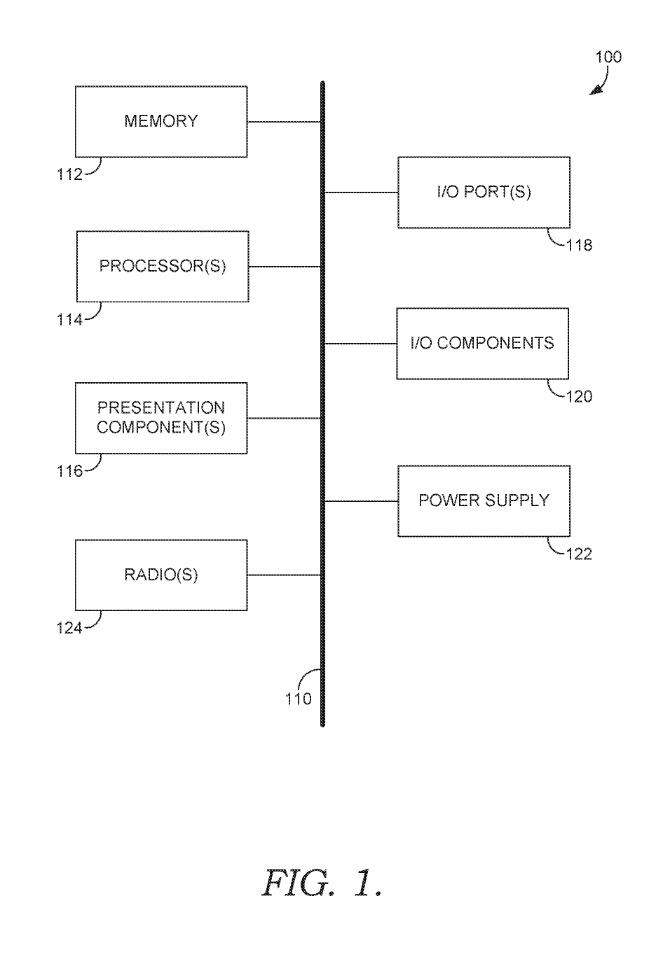

Referring now to the Figures, with reference to FIG. 1, FIG. 1 depicts a computing device 100 that includes a bus 110 that directly or indirectly couples the following devices: memory 112, one or more processors 114, one or more presentation components 116, one or more input/output (I/O) ports 118, one or more I/O components 120, an illustrative power supply 122, and an illustrative radio 124 which can be implemented as a wireless communication device. Bus 110 represents what can be one or more buses (such as an address bus, data bus, or combination thereof). Although the various blocks of FIG. 1 are shown with lines for the sake of clarity, in reality, these blocks represent logical, not necessarily actual, components. For example, one can consider a presentation component such as a display device to be an I/O component. Also, processors have memory. The inventor(s) hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “client device/system,” “user device,” “computing device,” or “server system,” as all are contemplated within the scope of FIG. 1.

Computing device 100 typically includes a variety of computer-readable media. As previously noted, computer-readable media can be any available media that can be accessed by computing device 100 and includes both volatile and nonvolatile, removable and non-removable media. By way of example, and not limitation, computer-readable media can be any available media that can be accessed by a computing device and includes both volatile and nonvolatile media, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 100. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 112 includes computer storage media in the form of volatile and/or nonvolatile memory. The memory can be removable, non-removable, or a combination thereof. Exemplary hardware devices include solid-state memory, hard drives, and optical-disc drives. Computing device 100 includes one or more processors 114 that read data from various entities such as memory 112 or 1/0 components 120. Presentation component(s) 116 presents data indications to a user or other device. Exemplary presentation components include a display device, speaker, printing component, vibrating component, and the like.

The I/O ports 118 allow computing device 100 to be logically coupled to other devices, including I/O components 120, some of which can be built in. Illustrative components include a microphone, joystick, game pad, satellite dish, scanner, printer, wireless device. Some embodiments of computing device 100 can include one or more radio(s) 124 (or similar wireless communication components). The radio 124 transmits and receives radio or wireless communications. The computing device 100 can be a wireless terminal adapted to receive communications and media over various wireless networks. Computing device 100 can communicate via wireless protocols, such as code division multiple access (“CDMA”), global system for mobiles (“GSM”), or time division multiple access (“TDMA”), as well as others, to communicate with other devices. The radio communications can be a short-range connection, a long-range connection, or a combination of both a short-range and a long-range wireless telecommunications connection. When the present description refers to “short” and “long” types of connections, it is not meant to refer to the spatial relation between two devices. Instead, it is referring to short range and long range as different categories, or types, of connections (i.e., a primary connection and a secondary connection). A short-range connection can include, by way of example and not limitation, a Wi-Fi connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection can include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the present invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and can be employed without reference to other features and sub-combinations and are contemplated within the scope of the claims.

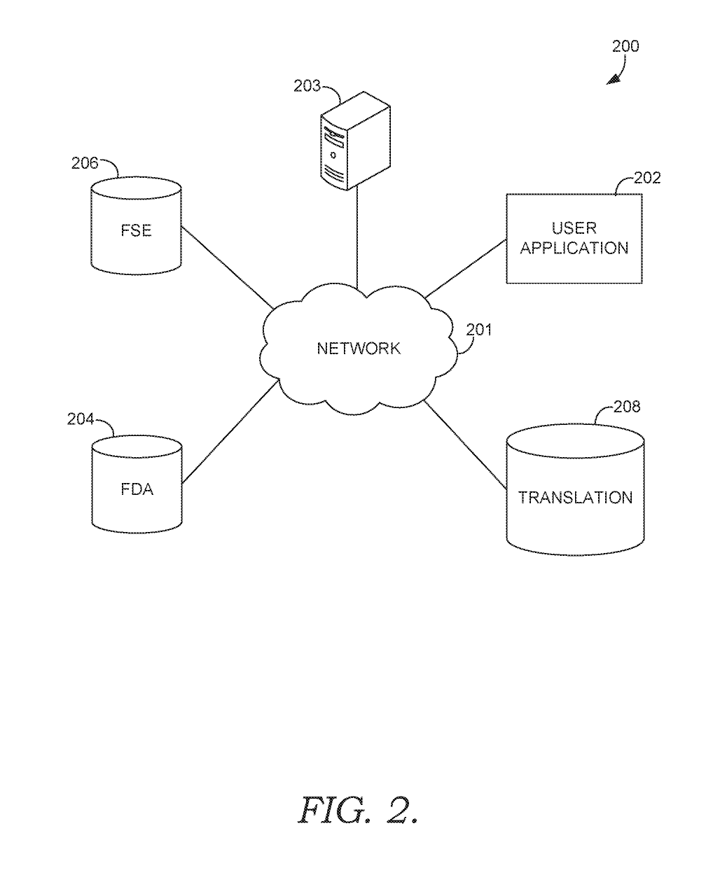

With reference now to FIG. 2, FIG. 2 depicts an aspect of an exemplary operating environment 200 suitable for practicing an embodiment of the technologies described herein. It should be understood that this and other arrangements described herein are set forth only as examples. Other arrangements and elements (e.g., machines, devices interfaces, functions, orders, and groupings of functions) can be used in addition to or instead of those shown, and some elements can be omitted altogether for the sake of clarity. Further, many of the elements described herein are functional entities that can be implemented as discrete or distributed components or in conjunction with other components, and in any suitable combination and location.

Additionally, the present disclosure shows certain items in block-diagram form more for being able to reference something consistent with the nature of a patent specification than to imply that a certain component is or is not part of a certain device. Similarly, although some items are depicted in the singular form, plural items are contemplated as well (e.g., what is shown as one data store may really be multiple data stores distributed across multiple locations). But showing every variation of each item might obscure the invention. Thus, for readability, the present description may show and reference items in the singular (while fully contemplating, where applicable, the plural).

Operating environment 200 is one example of a suitable environment and system architecture for implementing an embodiment of the disclosure. As described above, some embodiments may be implemented as a system, comprising one or more computers and associated network and equipment, upon which a method or computer software application is executed. Accordingly, aspects of the present disclosure may take the form of an embodiment combining software and hardware aspects that may all generally be referred to herein as a “module” or “system.” Further, the methods of the present disclosure may take the form of a computer application embodied in computer readable media having machine-readable application software embodied thereon. In this regard, a machine-readable storage media may be any tangible medium that can contain, or store a software application for use by the computing apparatus.

As shown in FIG. 2, example operating environment 200 provides an aspect of a computerized system for compiling and/or running aspects of this disclosure, which in some embodiments may include identifying an indication of an avoidance parameter. Among other components not shown, example operating environment 200 includes a user application 202, a plurality of data stores 204, 206, and 208, and a computer system 203 (e.g., a server). Each of the components shown in FIG. 2 can be implemented via any type of computing device, such as computing device 100 described in connection to FIG. 1, for example. These components can communicate with each other via network 201, which can include, without limitation, one or more local area networks (LANs) and/or wide area networks (WANs). In example embodiments, network 201 comprises the Internet and/or a cellular network, amongst any of a variety of possible public and/or private networks. Furthermore, items shown communicatively coupled to network 201 may be directly communicatively coupled to other items shown communicatively coupled to network 201.

It should be understood that any number of user devices, servers, and data sources/stores can be employed within operating environment 200 within the scope of the present disclosure. Each can comprise a single device or multiple devices cooperating in a distributed environment. For instance, computer system 203 can be provided via multiple devices arranged in a distributed environment that collectively provide the functionality described herein. Additionally, other components not shown can also be included within the distributed environment. Additionally, embodiments of the present technology may be implemented as a cloud-based platform or may be distributed across multiple physical locations.

Example operating environment 200 includes data stores 204, 206, and 208 (or storage 204, 206, and 208), which in some embodiments includes food item data, customer data, proprietary food service provider data, and the like. It is contemplated that the term data includes any information that can be stored in a computer-storage device or system, such as user-derived data, computer-useable instructions, software applications, or other information. Further, although depicted as separate data stores in FIG. 2, data stores 204, 206, and 208 may be combined into a single data store, be distributed among more data stores than shown in FIG. 2, or may be in the cloud.

Data store 204 generally refers herein to a data store including information from the United States Department of Agriculture's (USDA) Food Composition Database. The data store 204 may replicate the USDA Food Composition Database or be a direct access to the USDA's Food Composition Database itself. The USDA Food Composition Database includes over 268,000 individual food items, both packaged and whole. Users are able to input additional entries into this data store 204 if the entry is not already present. This information is valuable since many inventory items for food service entities are manufactured foods with ingredient lists that are not stored in the USDA Food Composition Database.

Custom inventory items (and their ingredients), menus, components, recipes, surfaces, and combinations thereof may be accessed through data store 206. Data store 206 is a secured, proprietary database available to only authorized users. Proprietary food item information such as recipes, proportions, ingredient amounts, etc., may be input into data store 206 by an authorized user for use with, for example, computer system 203. No proprietary information from a first user is available to a second user without explicit authorization (e.g., a list of authorized users associated with an account and corresponding access credentials). For example, one food service entity cannot access information of another food service entity. Data store 206 may include proprietary information from a plurality of food service entities and maintain the proprietary nature of the information for each by requiring the necessary, unique, validating credentials to access the information.

Additionally, various access levels of information may be available within a food service entity such that information may be available to various individuals based on their access level. For example, a food service entity's owner may have full access to read and write all data. Other users (e.g., staff) may only have read access. Furthermore, the read access may be further segmented into read 1 access, read2 access, etc., where one level of read access allows reading all data, another level allows reading only portions of data, etc. By way of specific example, the specifics of the recipe, such as proportions or ingredient amounts, may not be accessible by the front of the house server or customer to preserve the proprietary nature of the information. Users without necessary credentials (i.e., access rights) are not able to access the proprietary information.

Data store 208 is a database including mappings for food translations. This does not currently exist outside of the present invention. Ingredients may be derived from multiple common foods and the common food terms database (i.e., data store 208) includes a mapping for these items. For example, maltodextrin can be made from corn, rice, potato, and wheat. Thus, the data store 208 may include multiple mappings for an ingredient to several different terms. Additionally, food labels may often include additional label items such as “may contain” or “processed in a facility with”, which are voluntary and relatively unregulated. These indications are also mapped and tracked by the data store 208 for use with computer system 203.

Example operating environment further includes user application 202. User application 202 may run on any type of computing device capable of use by a user. Although environment 200 depicts an indirect communicative coupling between user application 202 and computer system 203, it is contemplated that an embodiment of user application 202 is communicatively coupled to computer system 203 directly. An embodiment of user application 202 comprises a software application or set of applications residing on a client computing device (or distributed in the cloud and on a client computing device) such as a personal computer, laptop, smartphone, tablet, or mobile computing device. In an embodiment, user application 202 is a Web-based application, and may be used to provide or manage services provided by an embodiment of the disclosure, which may be used by a food service provider for managing food service items.

Some embodiments of user application 202 include a graphical user interface enabling an authorized user to enter narrative information for analytical processing, and may further include one or more graphical user interfaces for presenting or receiving information about a context of a particular activity being monitored (such as a diner with a food item avoidance being served) and one or more graphical user interfaces for presenting a notification that a particular item includes an indication of an avoidance parameter. For instance, in one embodiment, color-coded menus may indicate safe, potentially safe, or unsafe for a subject. Further still, some embodiments of user application 202 include a user interface that includes suggestions for modifying or amending items that are determined to be potentially safe.

Example operating environment 200 further includes computer system 203, which may take the form of a server, which is communicatively coupled through network 201 to data stores 204, 206, and 208, and/or user application 202.

Computer system 203 comprises one or more processors operable to receive instructions and process them accordingly, and may be embodied as a single computing device or multiple computing devices communicatively coupled to each other. In one embodiment, processing actions performed by computer system 203 are distributed among multiple locations such as one or more local clients and one or more remote servers, and may be distributed across the other components of example operating environment 200. For example, a portion of computer system 203 may be embodied on user application 202. In one embodiment, computer system 203 comprises one or more computing devices, such as a server, desktop computer, laptop, or tablet, cloud-computing device or distributed computing architecture, a portable computing device such as a laptop, tablet, ultra-mobile P.C., or a mobile phone.

Embodiments of computer system 203 include a computer software stack, which in some embodiments operates in the cloud, as a distributed system within computer system 203, and includes an operating system. The operating system may be implemented as a platform in the cloud, and which is capable of hosting a number of services to identify avoidance parameters. Embodiments of the services run as a local or distributed stack in the cloud, on one or more personal computers or servers such as computer system 203, and/or application 202. In embodiments, user application 202 and/or system 203 operate in conjunction with the software stack.

In application, a food service entity has many different items and activities to track in order to be a responsible food service provider for patrons with, for example, food allergies, food intolerances, dietary restrictions, food preferences, and the like. There is no current solution to identify all unsafe or potentially safe items within a menu, regardless of the reason for the unsafe designation. If there is a food ingredient that has been deemed unsafe for any reason, the food service entity should be able to determine the extent to which that food ingredient affects the menu.

The underlying logic in the present disclosure may be used in multiple applications across different industries. For instance, all food industries would need to be notified of a recall or outbreak that affects a particular food ingredient they use in order to modify the menu for that shift or service until a new ingredient can be identified/procured. The logic herein can apply to any outbreak information and apply to the entire menu such that the application provides a clear view of the entire menu unaffected (or affected) by the recall or outbreak. Additional industries include, but are not limited to, healthcare, schools, restaurants, hospitality industries, and memberships (e.g., golf clubs, etc.). The industries span those with static food offerings and dynamically changing offerings (e.g., daily specials, seasonal menus, and schools have different menus each day, etc.).

A user, regardless of industry, would be able to enter into, for example, data store 206, menus built up from recipes (or menu items, used interchangeably herein), built up from components, built up from sub-components, etc. Each recipe, or menu item, can contain multiple components, each of which can be a recipe in and of itself. Each of those component recipes can also include multiple components, each of which can be a recipe in itself, and so on. There is no limit to the depth of this recursion.

The components can be recipes or inventory items. Inventory items, as previously discussed, may be manufactured foods with ingredient lists. The manufactured food information may be identified from data store 204. Custom entries may be provided into data store 206. The custom inventory items (and their ingredients), menus, components, recipes, surfaces, and combinations are stored in data store 206. This is also where the food service entity may enter specifics of the recipes including proportions or ingredient amounts, although proportions and ingredient amounts are not required.

Each recipe may be designated as “on the menu” or “off the menu.” Only recipes that are currently “on the menu” are taken into consideration in the search for food avoidance parameters, including cross-contamination. This designation allows food service entities to keep all menu items in data store 206 whether or not those items are currently being prepared. If an item is “off the menu” it is not taken into consideration for the search. This saves processing power of the computer system performing the analysis. Alternatively, those items may be considered and then filtered from display and delimited from the graphical user interface. This intelligent delimiting of information from the graphical user interface also saves computational resources.

Continuing on to the data entry, each recipe may be designated with its cooking surface in the particular kitchen. The cooking surface, or equipment used during cooking, can be noted with respect to each recipe, along with a designation of whether the recipe can be cooked without the shared piece. When two recipes are found on the same cooking surface, it is known that cross-contamination or cross-contact occurs. For example, if grilled shrimp and a hamburger are both cooked on the same grill surface, a shellfish allergic diner should not consume the hamburger. The food service entity may enter the correct set of cooking surfaces for each item of a recipe into data store 206. Given the recursive nature of recipes and that each component of a recipe could have separate cooking equipment and can, therefore, be individually contaminated by another recipe sharing that equipment, great logic and care must be considered to ensure that the dish has not been contaminated at any level.

Each recipe may also be designated with the possibility of clean pan preparation (i.e., without the shared piece). In the previous example of the hamburger and grilled shrimp, the hamburger would have been safe had it been specially prepared for that diner in a clean pan. Additional cooking implement options may be contemplated and within the scope of this invention.

Each component (or sub-component) of a recipe may further be designated with a possibility of removal. By way of example, a salad may be prepared without inclusion of shredded cheese. Substitutions may also be included as suggested modifications, where applicable.

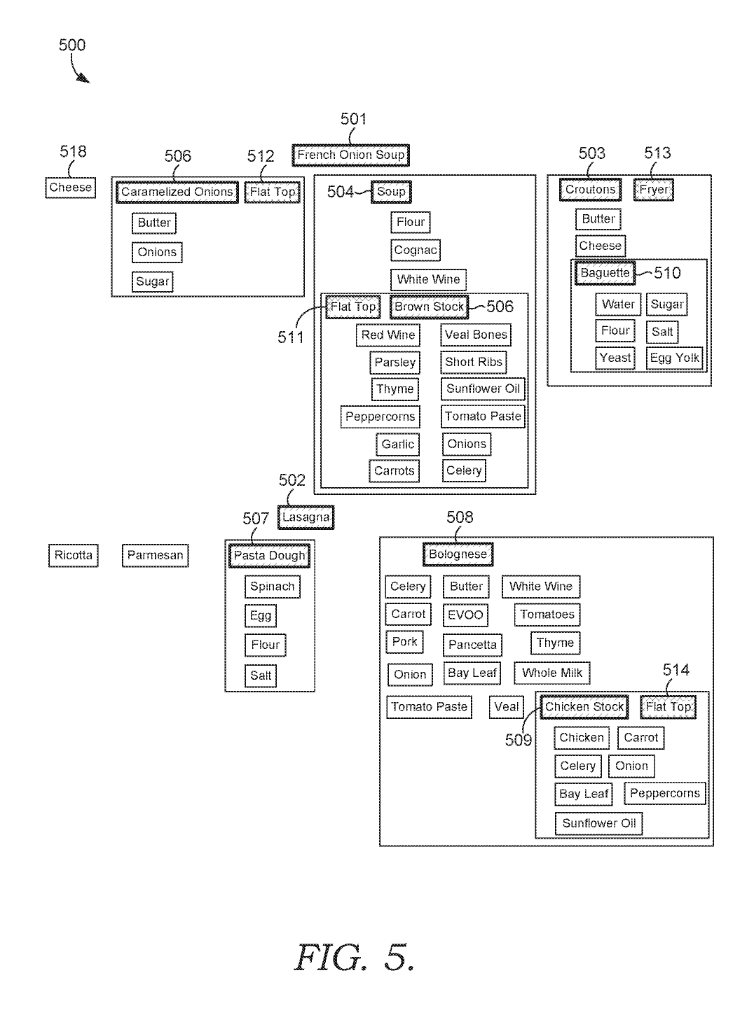

Thus, when determining if a dish is considered safe, unsafe, or potentially safe, analysis of every ingredient in every level of components in a recipe as well as all recipes and component recipes is done as well as further analysis of whether, at any level, any shared equipment is present. For instance, as shown in FIG. 5, a block diagram 500 of example recipe data is shown. Recipes 501 and 502 (French Onion Soup and Lasagna hereinafter) are both provided. Whole food components are indicated at reference numerals 503, 504, 505, 506, 507, 508, 509, and 510. Components of those recipes are shown below the whole food components. For instance, a component of Caramelized Onions (reference number 506) is Butter. Shared equipment is also indicated at reference numerals 511, 512, 513, and 514. Neither the French Onion Soup nor the Lasagna use shared equipment. However, both of them have component recipes that use shared equipment.

In this case, there are two third level components (levels are described below) that are both using the Flat Top (Brown Stock and Chicken Stock). If a customer were allergic to or trying to avoid chicken, then it is imperative that the food service entity not serve that customer either the Lasagna or the French Onion Soup, as there is a cross-contamination between the two. If only examining the ingredients or cooking and preparation method of the two recipes individually, the cross-contamination would be missed.

Neither the Chicken Stock nor the Brown Stock are removable, in this example. Thus, these items would have been marked as unsafe by the computer system 203. If the contamination were in a removable component, like the Croutons of the French Onion Soup, then the contaminated component may be marked as “please prepare without” or any other modification suggestion indication and placed in a potentially safe designation on the graphical user interface.

The present disclosure identifies various levels within recipes. FIG. 5 can be broken down to three levels, for example. The French Onion Soup and Lasagna are first level recipes. Each first level recipe can be broken down to second level components. The Lasagna includes second level components Ricotta, Parmesan, Pasta Dough, and Bolognese while the French Onion Soup includes second level components Cheese, Caramelized Onions, Soup, and Croutons. Second level components, where applicable, may be broken down to third level components. For instance, the second level component Croutons can be broken down into third level components including Butter, Cheese, and a Baguette. Each component can be further broken down until only whole ingredients remain. Each level of every recipe and its components are analyzed for avoidance parameters and cross-contamination, regardless of the depth, complication, and recursion of the menu item's components.

The ultimate determinations may include safe, potentially safe, and unsafe. Safe indicates no avoidance parameters or cross-contamination were identified. Unsafe indicates one or more of avoidance parameters or cross-contamination were identified and cannot be modified. Potentially safe indicates that one or more of avoidance parameters or cross-contamination was identified but a modification to re-designate the potentially safe item as safe has been identified and generated. This modification/suggestion is produced from the electronic determination of the reason for a potentially safe designation and whether any modifications are available. This intelligent decision, computed electronically by the system, is the result of a complex set of custom logic, maths, and information surrounding the recipe, its preparation, and the aforementioned cross-contamination logic.

In embodiments, the option to input multiple (i.e., more than one) avoidance parameters is provided. The entire set of menu items (recipes) is searched and analyzed against each of the potentially multiple avoidance parameters utilizing data stores 204, 206, and 208.

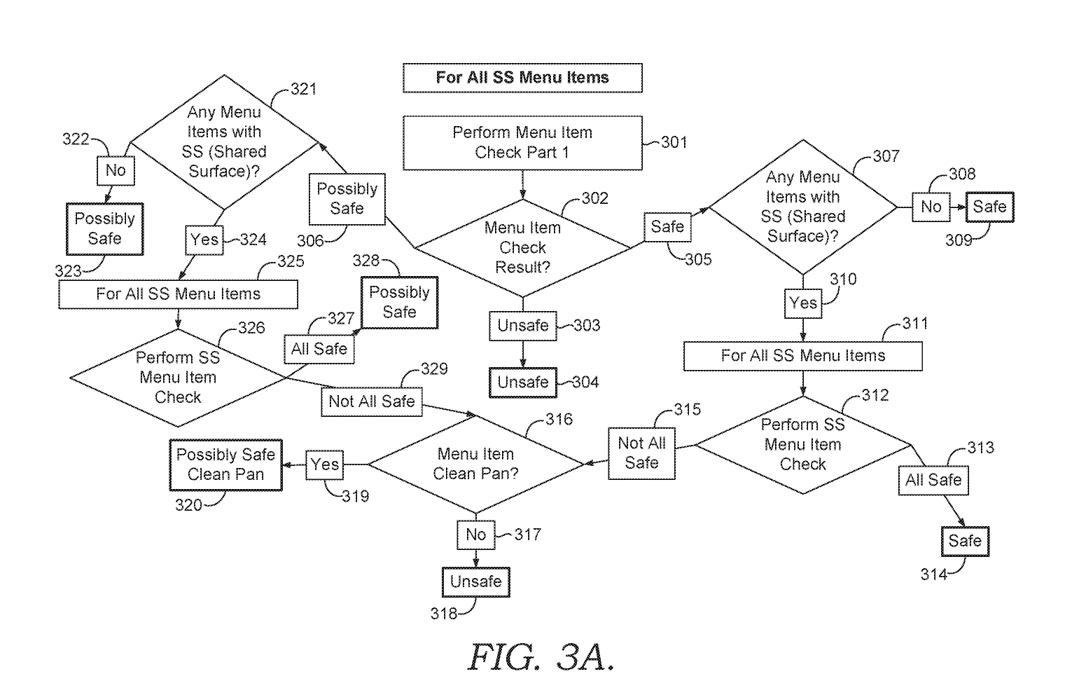

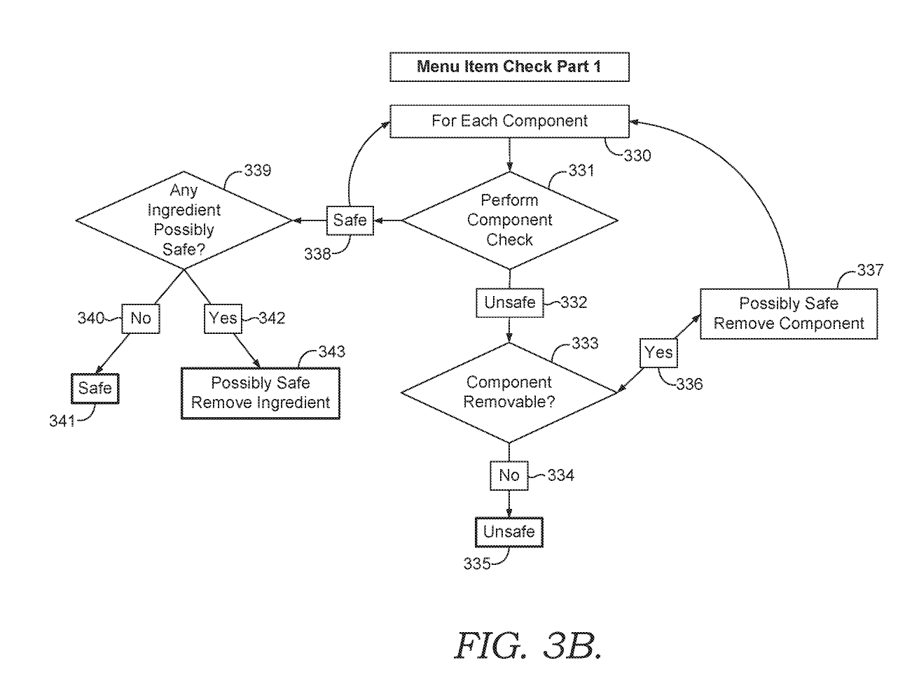

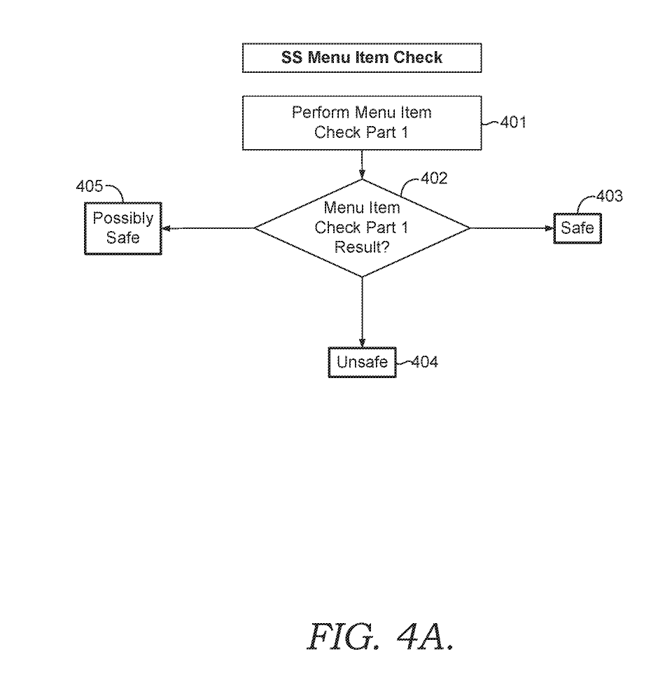

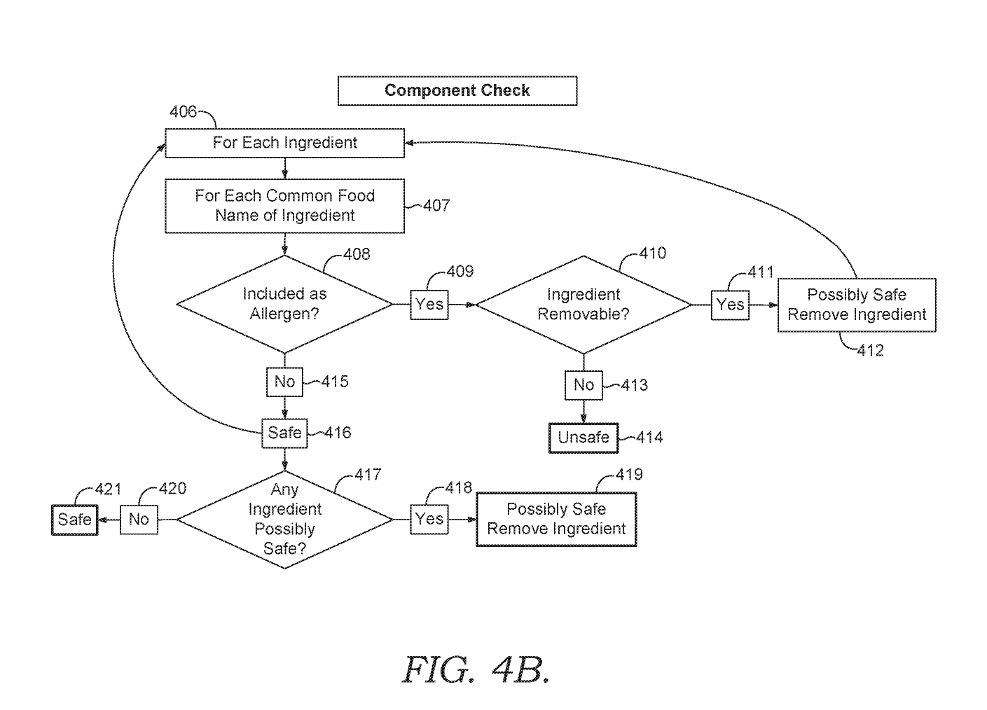

Turning now to FIG. 3A, FIG. 3A depicts a method for automatically identifying avoidance parameters. Some embodiments of the steps of the method may be carried out using one or more computer program routines. Initially, at block 301, a menu item check is performed and is illustrated at FIG. 3B. The menu item check is performed for every single ingredient of every component of every item of the menu. As shown in FIG. 3B, each component is identified at block 330 and a component check is performed at block 331, which is illustrated in FIG. 4B and discussed below. The results of the component check are utilized at block 331 to output unsafe or safe designations at blocks 332 and 338, respectively. Unsafe components are evaluated to identify whether a component is removable at block 333. If the component is not removable, a ‘no’ designation is made at block 334 and the component is identified as unsafe at block 335. If the component is removable, a ‘yes’ designation is made at block 336 and the component is identified as possibly safe with a removable component modification at block 337. Modifications, as used herein, refers generally to any change that can be made to the item that affects the avoidance parameter (e.g., substitution, removal, different cooking surface, etc.). The method returns to the identification of components at block 330 for each component present in the menu item(s) until every component is drilled down to the whole food(s) component.

Returning now to block 331, safe components are evaluated to determine whether any ingredients are possibly safe at block 339. If no, a ‘no’ designation is made at block 340 and the component is identified as safe at block 341. If yes, a ‘yes’ designation is made at block 342 and the component is identified as possibly safe with a removable ingredient modification at block 343.

This continues for each component identified. The recursive nature of the invention is critical to ensuring that every single ingredient of every component of every menu item is checked. Thus, the menu item check of FIG. 3B evaluates every component of a menu item and identifies each as safe, unsafe, or possibly safe (with modifications).

FIG. 4B, as mentioned, provides the component check (performed at block 331 of FIG. 3B). A component check is performed for each ingredient at block 406. Each common food name of the ingredient is identified and included in the component check at block 407. The system determines whether the ingredient (or common name thereof) is identified as an allergen (or any other avoidance parameter) at block 408. If yes, a ‘yes’ designation is made at block 409 and the ingredient is determined to be removable or non-removable at block 410. If the ingredient is not removable, a ‘no’ designation is made at block 413 and the ingredient is identified as unsafe at block 414. If the ingredient is removable, a ‘yes’ designation is made at block 411 and the ingredient is identified as possibly safe with a removable modification at block 412. The method returns to block 406 for each ingredient until every ingredient has completed the component check.

If the ingredient is not identified as an allergen (or any other avoidance parameter) at block 408, a ‘no’ designation is made at block 415 and the ingredient is identified as safe at block 416. A determination is made at block 417 whether any ingredient is possibly safe. If no, a ‘no’ designation is made at block 420 and the ingredient is identified as safe at block 421. If yes, a ‘yes’ designation is made at block 418 and the ingredient is identified as possibly safe with a removable modification at block 419.

Returning now to FIG. 3A, the results of the menu item check are utilized at block 302 to identify unsafe items at block 303. Because no modifications are identified with the unsafe items, the unsafe items are designated as unsafe at block 304. Safe items are identified at block 305. Further analysis is performed on the safe items to determine if any of the safe items have a shared surface (“SS”) at block 307. If no shared surfaces are identified at block 307, a ‘no’ designation is identified at block 308 and the item is designated as safe in block 309. If a shared surface is identified at block 307, a ‘yes’ designation is identified at block 310. All items receiving a ‘yes’ designation at block 310, as indicated at block 311, proceed to a shared surface menu item check at block 312. The shared surface menu item check is illustrated in FIG. 4A. In the shared surface menu item check, the menu item check provided in FIG. 3B is performed at block 401 for each item having a shared surface. A result is determined at block 402 and designated as safe at block 403, unsafe at block 404, or possibly safe at block 405.

Returning to FIG. 3A, when the shared surface menu item check determines at block 312 that all items are safe, an ‘all safe’ designation is made at block 313 and the items are identified as safe at block 314. When the shared surface menu item check determines at block 312 that not all items are safe, a ‘not all safe’ designation is made at block 315 and a clean pan check is performed at block 316. When a clean pan is not available for the item, a ‘no’ designation is made at block 317 and the item is identified as unsafe at block 318. If a clean pan is available at block 316, a ‘yes’ designation is made at block 319 and the item is identified at block 320 as possibly safe with a clean pan modification.

The menu item check of block 302 may also identify items as possibly safe at block 306. Possibly safe items are evaluated to determine if a shared surface is present for the item at block 321. If no shared surfaces are identified, a ‘no’ designation is made at block 322 and the item is deemed as potentially safe at block 323. If shared surfaces are identified at block 321, a ‘yes’ designation is made at block 324. All items receiving a ‘yes’ designation at block 324, as indicated at block 325, proceed to a shared surface menu item check at block 326. As mentioned, the shared surface menu item check is illustrated in FIG. 4A.

When the items sharing a surface are all safe, an ‘all safe’ designation is made at block 327 and the item is identified as possibly safe at block 328. When the items sharing a surface are not all safe, a ‘not all safe’ designation is made at block 329 and a clean pan determination is made at block 316. When a clean pan is not available for the item, a ‘no’ designation is made at block 317 and the item is identified as unsafe at block 318. If a clean pan is available at block 316, a ‘yes’ designation is made at block 319 and the item is identified at block 320 as possible safe with a clean pan modification. These checks drill down to the level where only whole items remain.

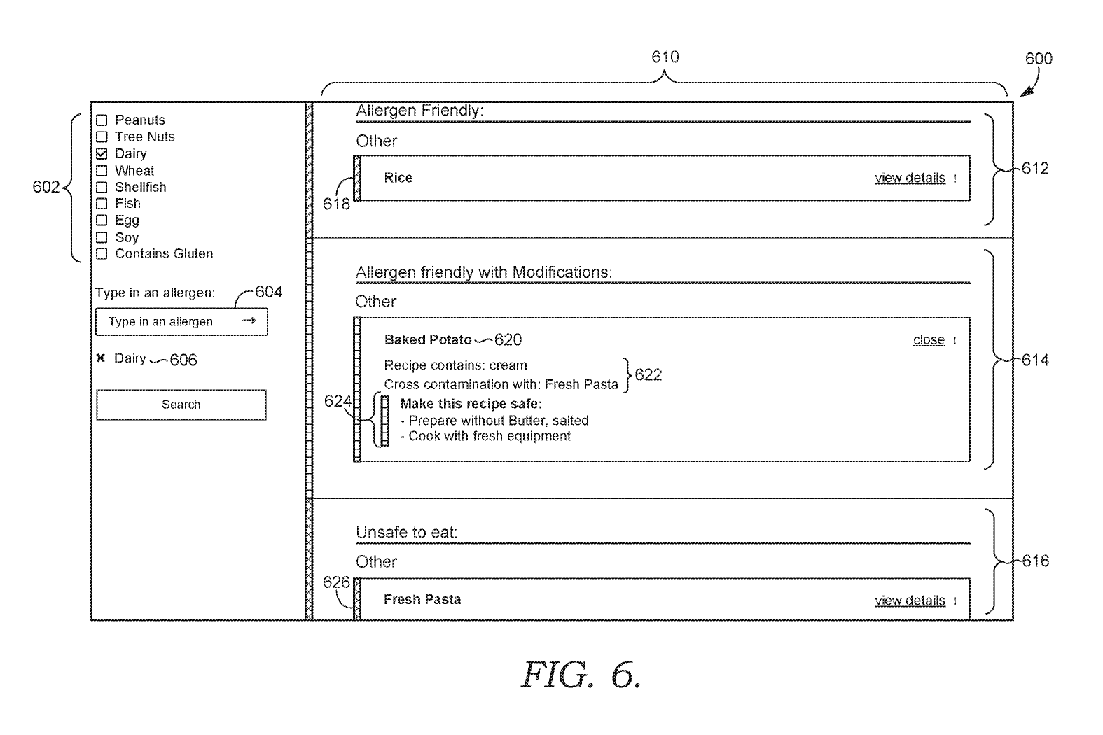

FIG. 6 provides an exemplary graphical user interface 600. As is shown, an avoidance parameters menu 602 is provided. Allergens are used as an example herein but other avoidance parameters such as dietary restrictions, outbreak information, and the like may be utilized. A search input area 604 is also provided such that additional avoidance parameters, if not provided in menu 602, may be searched. In this example, ‘Dairy’ has been selected from the menu 602 and is populated as search parameter 606. The results area 610 provides a safe area 612, an unsafe area 616, and a potentially safe area 614. The designations of safe, unsafe, and potentially safe may be termed any other name desired by a user (e.g., friendly, unfriendly, compliant, non-compliant, etc.). Additionally, each designation herein is presented in a way that clearly distinguishes one designation from the other. For instance, a stoplight-type style may be used such that unsafe items are in a red area, safe items are in a green area, and potentially safe items are in a yellow area. The bars on the left of the areas are currently hatched differently to illustrate the different designations, but color-coded menus are utilized in an embodiment of the present disclosure. As shown, a safe item 618 is populated. Note that the bar to the left of the item is the same hatching (or color, if using color-coding) as the bar to the left of the entire safe area 612. The same is true for unsafe item 626—the hatching is the same for the item and the menu bar. Thus, indicators utilized to distinguish designations may be applied to each of the items, the menu area, the modifications, or any combinations thereof.

The unsafe area 614 includes an unsafe item 620. The components identified with problems (e.g., cross-contamination or avoidance parameter matches) are shown in area 622. Suggestions/modifications are provided in modification area 624. Note that the modifications may also be associated with the designation indicator.

In this case, a dairy avoidance is shown. The Rice has no dairy, the Baked Potato has optional Butter, and the Fresh Pasta contains Butter that cannot be removed. Also, the Baked Potato and the Fresh Pasta are cooked in the same equipment, so there is a secondary modification to cook the Baked Potato in clean equipment.

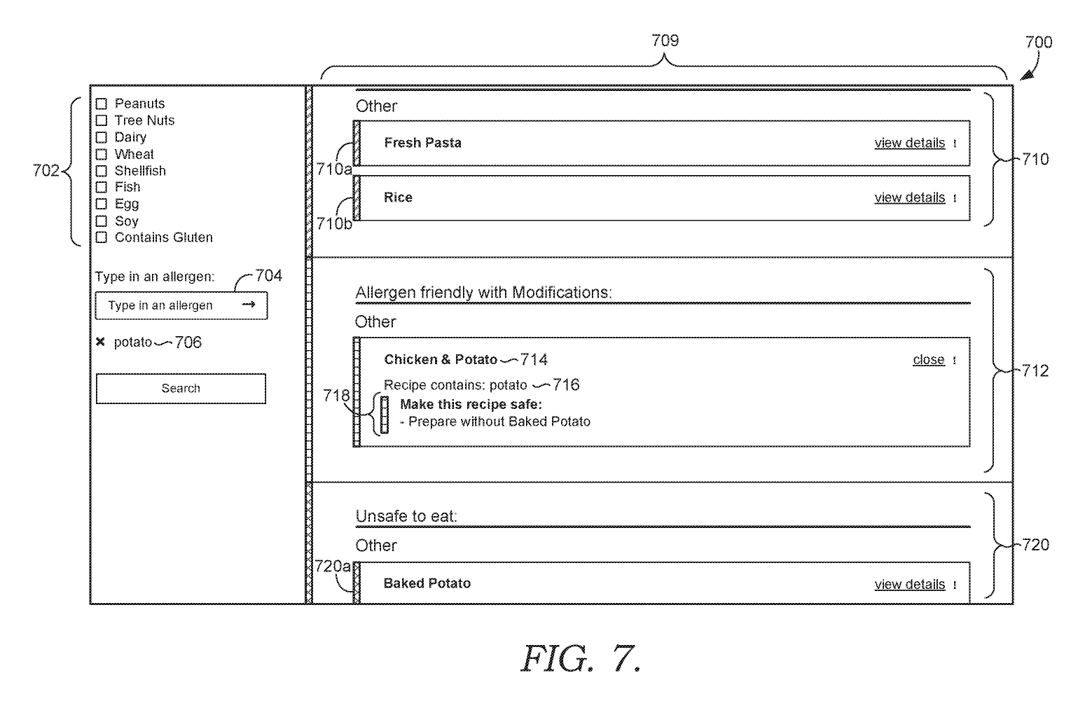

FIG. 7 illustrates another exemplary graphical user interface 700. Similar to what is shown in FIG. 6, FIG. 7 includes an avoidance parameters menu 702 and a search input area 704. Here, a user has manually input Potato into the search input area and the search parameter 706 is generated. A results area 709 is provided that includes a safe area 710, an unsafe area 720, and a potentially safe area 712. Safe items 710A and 710B are designated with safe indicators that match the hatching of the safe area 710. The same is true of the unsafe item 720A as it matches the hatching of the unsafe area 720.

As was shown in FIG. 6, FIG. 7 also includes a potentially safe item 714 with an explanation area 716 of why the item is potentially safe. A suggestions/modifications area 718 is also provided including one or more modifications to re-designate the item as safe.

In this example, a Baked Potato has been added as a component to a dish called Chicken and Potato. The Potato component is removable from the higher-level menu item. The search is for Potato (not in the Top 8 allergens and a rather unusual allergen). The Baked Potato item comes back unsafe, as it cannot be removed from the dish. The Chicken and Potato dish comes back as potentially safe with the modification of removing the Baked Potato component.

FIGS. 6 and 7 illustrate that the food server and/or diner are provided with a sectioned list of menu items on a graphical user interface. The sections may be safe, unsafe, and potentially safe (or any other naming convention desired by a user). Each menu item's details may be accessed by choosing the menu item. The details include the components of the recipe (not the proportions as to protect the trade secrets or proprietary information of the food service entity) and the designation of safe, unsafe, or potentially safe. With this output, the server and the diner have sufficient knowledge to select menu items for consumption that are highly unlikely to cause the diner to suffer from outbreaks, contamination, illness, food-related conditions, or life-threatening allergic reactions.

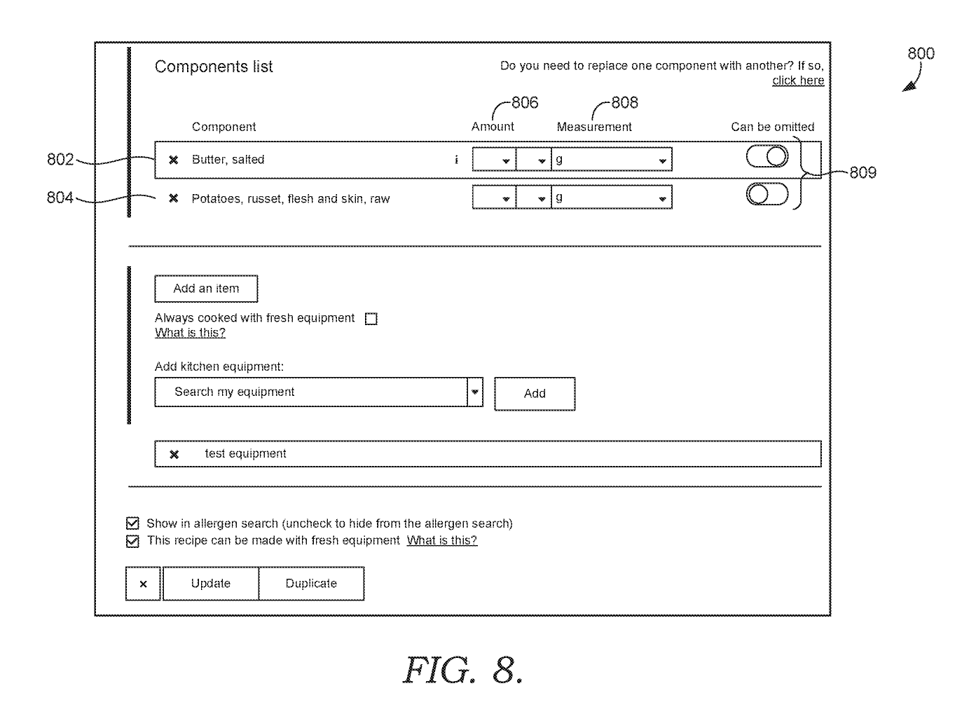

FIG. 8 provides an interface 800 for input of components. As is shown, individual components 802 and 804 may be entered along with amounts 806 and measurements 808, although neither amounts nor measurements are required. A removal designation may be made in omit area 809 to indicate whether a component is removable. Additional items may be added. As is shown, information related to the equipment may also be collected such as whether the item is always cooked with fresh equipment. Information associated with the equipment may also be input. Options may also be provided to include or not include the item in the search and to offer the option to cook an item with fresh equipment for the cross-contamination analysis, as shown in the interface 800.

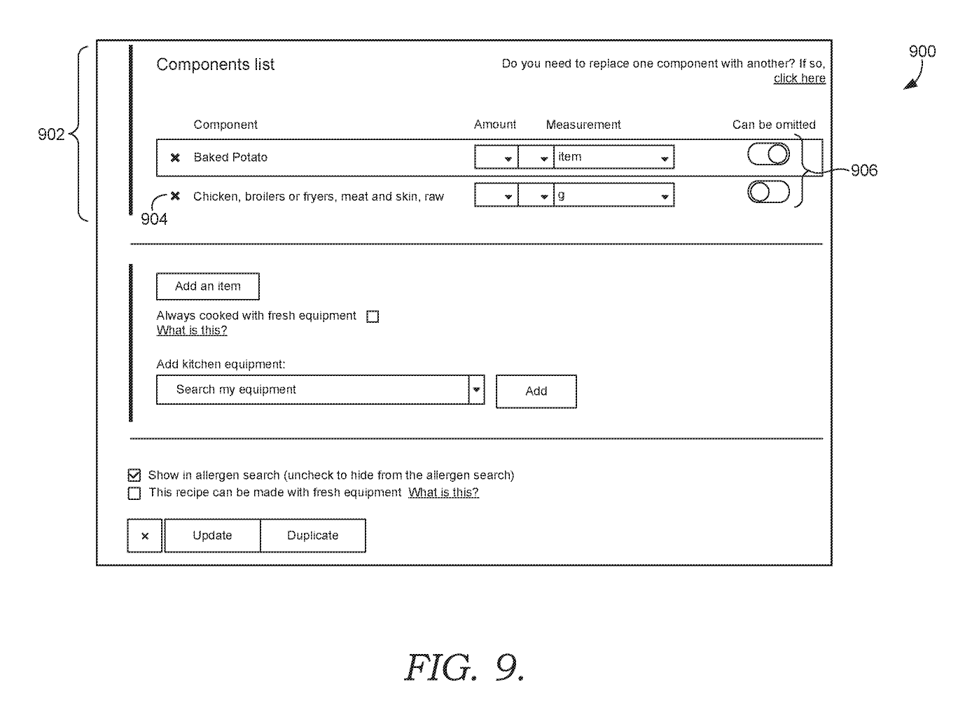

FIG. 9 provides another interface 900 where components are added such as component 904 into component area 902. An omit area 906 is present to indicate if the item can be eliminated from its respective recipe. Items may be added and a designation for whether the item can be prepared with fresh equipment is provided. Again, equipment may be added. Options may also be provided to include or not include the item in the search and to offer the option to cook an item with fresh equipment for the cross-contamination analysis.

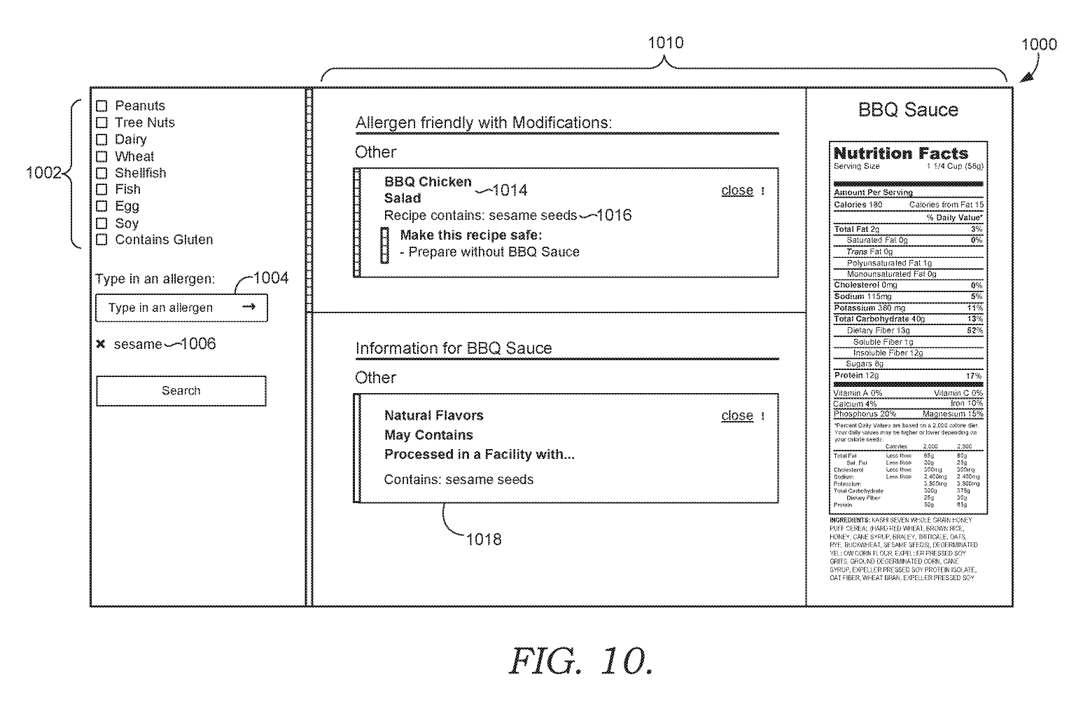

FIG. 10 provides another interface 1000 that includes an avoidance parameter menu 1002 and a search input area 1004. Here, a user has input Sesame into search bar 1004 and it is generated as search parameter 1006. The results area 1010 is provided with an individual category selected (e.g., potentially safe). This view may be provided upon selection of an item shown as potentially safe in a first view, such as the interfaces shown in FIGS. 6 and 7. The designation identifier (e.g., hatching, color-coding, etc.) may or may not be provided in this results area 1010. An ingredient label is further provided in results area 1010. Here, the BBQ Chicken Salad item 1014 is shown as potentially safe because the BBQ Sauce used on the BBQ Chicken Salad includes Sesame Seeds (indicated by the explanation area 1016), as shown in the BBQ Sauce ingredient label. Suggestions to make the recipe safe are provided and include preparing the BBQ Chicken Salad without the BBQ sauce.

Additionally, information from the label may be extracted and populated in label detailed area 1018. This area highlights, among other things, that the BBQ Sauce includes Sesame Seeds. It may also include, where applicable, if the label includes an issue related to the “may contains” or “processed in a facility with” modifiers. If present, those issues would be noted in the label detailed area 1018.

The underlying logic in the present disclosure, as noted above, is used in multiple applications across different industries. The ability to identify multiple food avoidances within a menu and provide options is shown in different capacities in the following use cases for various applications.

Food Safety, all industries: Should the establishment be notified of a recall or an outbreak that affects a particular food ingredient they use, they must modify the menu for that shift or service until a new ingredient can be identified and procured. The present disclosure provides a clear view of the entire menu unaffected by the recall or outbreak, along with any possible modifications for affected items to keep their guests safe from food safety harm.

Food avoidance in Restaurants: In the restaurant industry, the common case is that the menu, or set of menus, is relatively static over some period of time. The guests, on the other hand, and the foods they must avoid (for the purposes of allergens, intolerances or other dietary restrictions), are unpredictable before the start of any given service or shift. When a guest arrives at a restaurant, the staff tries to accommodate the set of foods to be avoided and find some subset of menu items that are likely to be safe. The present disclosure provides a complete set of possible friendly and modifiable options for the guest, as well as a complete set of unsafe options that can be ruled out as possibilities.

Food avoidance in Schools: In schools and other educational or childcare institutes (universities, camps, preschools, etc.), the common case is that the menu changes each day, or on a cycle and the set of students and the foods they must avoid (for the purposes of allergens, intolerances or other dietary restrictions), are static each day. The menu each day is relatively limited and the staff must figure out each day which students can eat the standard fare and which students must be fed something modified or, alternatively, something off the menu all together. The argument can be made that food avoiding children should provide their own food, but there are many situations in which the students are unable to do so. The student may be a part of a free- or reduced-school lunch or breakfast program, the school may have a no outside food policy, or a camp may be too lengthy and not have the available facilities to allow the student to prepare or provide his or her own food at all. The present disclosure provides a complete set of students for whom the standard menu is available, the students who require some amount of modification as well as the students who require an entirely different meal to be prepared.

Food avoidance in Healthcare: Similarly to schools, healthcare facilities like hospitals, rehabilitation facilities, and assisted living and nursing homes have a population of patients that is relatively static and a menu that changes daily or on a cycle. There is the additional factor of visitors who may dine in the healthcare facility as well as the set of patients for whom food is provided. The visitors to the facility are unpredictable to the staff and will require an additional food avoidance recognition to the standard set of patients. This use case brings the two already described together, serving both a static set of patients as well as a revolving set of visitors, both with a revolving menu.

Food avoidance in Membership: Membership facilities, such as country clubs or golf courses, have a static set of members, not all of whom may arrive each day as well as an unpredictable set of visitors. The menu is generally changing or on a cycle.

Food avoidance in Hospitality: Hotels, cruise lines, and resorts have a set of guests who stay for some amount of time and may eat multiple meals within the available food service establishments. During the course of a guest's stay, the food avoidances that need to be accommodated are unlikely to change. The menus of each establishment are also likely to be relatively static. The guest should be able to be accommodated at each food service establishment available to him or her without having to go through the challenging conversation with each individual staff.

Food avoidance in Loyalty: Expanding upon the restaurant and hospitality use cases listed above, the food avoidance recognition within menu claims are also applicable to Loyalty Programs. The foods that a loyalty program member needs to avoid should not need to be entered into the software with each visit made by the guest.

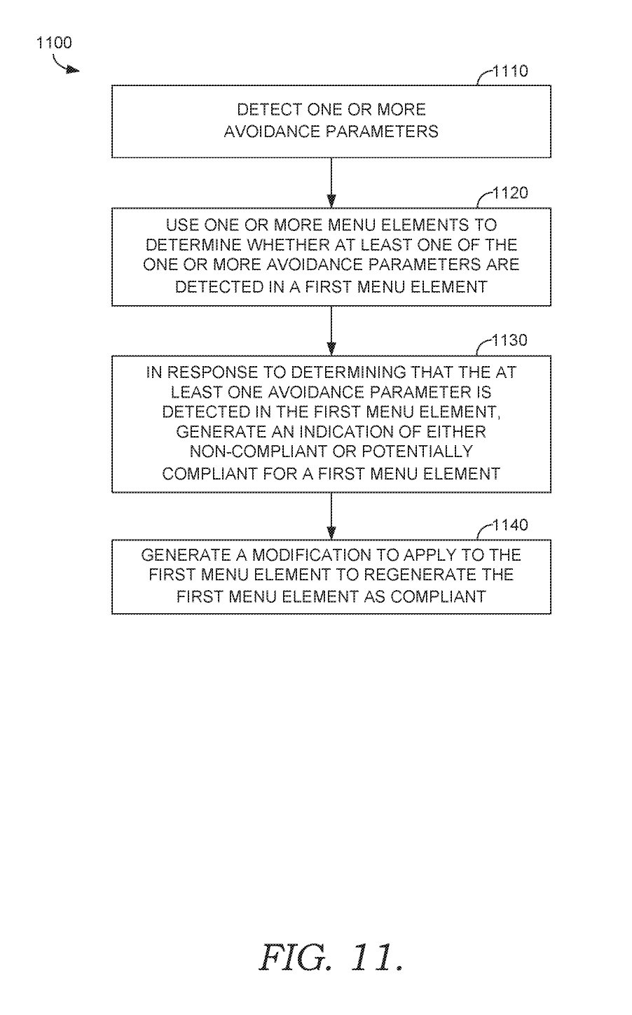

FIG. 11 is a flow diagram of an exemplary method, in accordance with some aspects of the technology described herein. At block 1110, one or more avoidance parameters is detected. One or more menu elements or items is used at block 1120 to determine whether at least one of the one or more avoidance parameters are detected in a first menu element. In response to determining that the at least one avoidance parameter is detected in the first menu element, an indication of either non-compliant or potentially compliant is generated for a first menu element at block 1130. At block 1140, a modification to apply to the first menu element to regenerate the first menu element as compliant is generated.

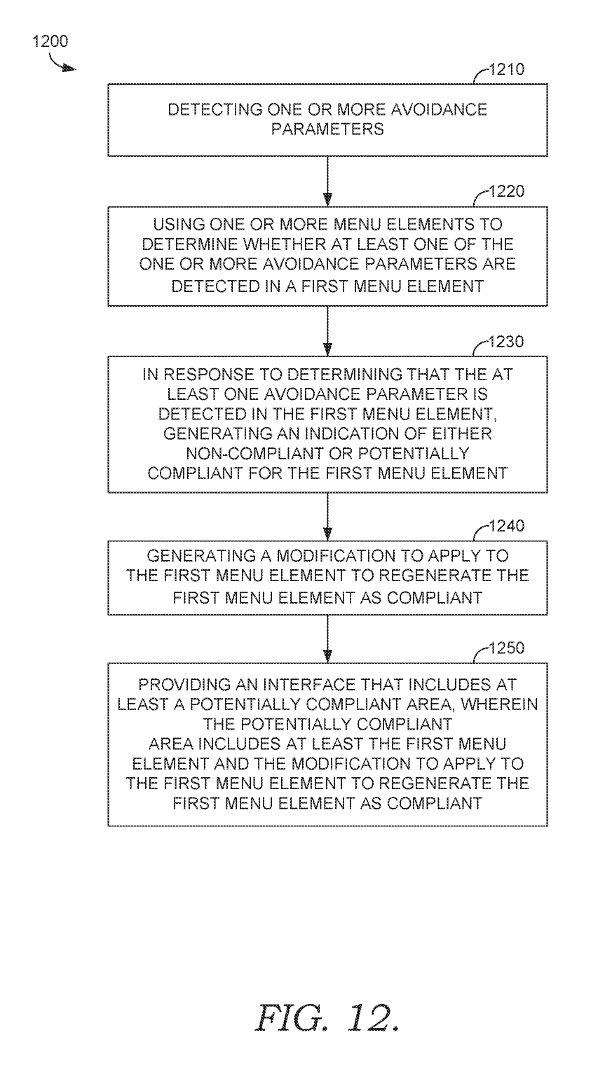

FIG. 12 is a flow diagram of an exemplary method, in accordance with some aspects of the technology described herein. At block 1210 one or more avoidance parameters is detected. One or more menu elements are used to determine whether at least one of the one or more avoidance parameters are detected in a first menu element at block 1220. In response to determining that the at least one avoidance parameter is detected in the first menu element, an indication of either non-compliant or potentially compliant for a first menu element is generated at block 1230. At block 1240 a modification to apply to the first menu element to regenerate the first menu element as compliant is generated. At block 1250 an interface that includes at least a potentially compliant area is provided, wherein the potentially compliant area includes at least the first menu element and the modification to apply to the first menu element to regenerate the first menu element as compliant.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and sub-combinations are of utility and may be employed without reference to other features and sub-combinations and are contemplated within the scope of the claims. Not all steps listed in the various figures need be carried out in the specific order described. Accordingly, the scope of the invention is intended to be limited only by the following claims.

What is claimed is:

1. A system for searching avoidance parameters, the system comprising:
one or more processors that:
detect one or more avoidance parameters;
use one or more menu elements to determine whether at least one of the one or more avoidance parameters are detected in a first menu element;
in response to determining that the at least one avoidance parameter is detected in the first menu element, generate an indication of either non-compliant or potentially compliant for a first menu element; and
generate a modification to apply to the first menu element to regenerate the first menu element as compliant.

2. The system of claim 1, wherein the determining step comprises:
identifying one or more components of the one or more menu elements.

3. The system of claim 2, wherein the one or more processors are further configured to translate the one or more components to common food terms.

4. The system of claim 2, wherein the one or more components is ingredients.

5. The system of claim 1, wherein the one or more processors are further configured to identify a cross-contamination risk associated with each of the one or more menu elements.

6. The system of claim 1, wherein the modification is a removal of a first component.

7. The system of claim 1, wherein the modification is a replacement of a first component with a second component different from the first component.

8. The system of claim 1, wherein the modification is a different cooking surface.

9. The system of claim 1, wherein the avoidance parameter is an allergen.

10. A computer readable media having computer-executable instructions stored thereon for identifying avoidance parameters which, when executed by a processor, cause one or more processors to:
detect one or more avoidance parameters;
use one or more menu elements to determine whether at least one of the one or more avoidance parameters are detected in a first menu element;
in response to determining that the at least one avoidance parameter is detected in the first menu element, generate an indication of either non-compliant or potentially compliant for a first menu element; and
generate a modification to apply to the first menu element to regenerate the first menu element as compliant.

11. The computer readable media of claim 10, wherein the avoidance parameter is an allergen.

12. The computer readable media of claim 10, wherein the determining step comprises identifying one or more components of the one or more menu elements.

13. The computer readable media of claim 12, wherein the computer-executable instructions further cause the one or more processors to translate the one or more components to common food terms.

14. The computer readable media of claim 12, wherein the one or more components is ingredients.

15. The computer readable media of claim 10, wherein the computer-executable instructions further cause the one or more processors to identify a cross-contamination risk associated with each of the one or more menu elements.

16. The computer readable media of claim 10, wherein the modification is a removal of a first component.

17. The computer readable media of claim 10, wherein the modification is a replacement of a first component with a second component different from the first component.

18. The computer readable media of claim 10, wherein the modification is a different cooking surface.

19. A method for detecting avoidance parameters, the method comprising:
detecting one or more avoidance parameters;
using one or more menu elements to determine whether at least one of the one or more avoidance parameters are detected in a first menu element;
in response to determining that the at least one avoidance parameter is detected in the first menu element, generating an indication of either non-compliant or potentially compliant for the first menu element;
generating a modification to apply to the first menu element to regenerate the first menu element as compliant; and
providing an interface that includes at least a potentially compliant area, wherein the potentially compliant area includes at least the first menu element and the modification to apply to the first menu element to regenerate the first menu element as compliant.

20. The method of claim 19, wherein the avoidance parameters may be detected upon identifying one or more cross-contaminations.
